(19) United States
(12) Patent Application Publication
(10) Pub. No.: US 2007/0247666 A1
(43) Pub. Date: Oct. 25, 2007

(54) Device, System And Method For Creation And Dissemination Of Customized Postcards

(76) Inventor: Kristen Tsitoukis, Collegeville, PA (US)

Correspondence Address: SYNNESTVEDT & LECHNER, LLP, 1101 MARKET STREET, 26TH FLOOR, PHILADELPHIA, PA, 19107-2950, US

(21) Appl. No.: 11/738,131

(22) Filed: Apr. 20, 2007

Related U.S. Application Data
(60) Provisional application No. 60/745,236, filed on Apr. 20, 2006.
(60) Provisional application No. 60/864,234, filed on Nov. 3, 2006.

(51) Int. Cl. G06K 15/00

(52) U.S. Cl. 358/1.18

(57) ABSTRACT

The device includes computer hardware and software that allows a user to create and disseminate a customized postcard, in either physical or electronic form. The user uses the device to select various design elements, which may include a template, a photograph/image taken with the user's digital camera and transmitted to the device, predetermined stock photographs/images stored on the device, predefined or user-provided free-form text, or a digitized form of the user's signature. The postcard may also include text that is applied automatically by the device, such as geographic locale- or resort-identifying text. For e-mailed or website-posted postcard images, the user may also include a music/sound file. The stock images and the sound files available for selection by a user using a specific device correspond to a specific locale in which the specific device is physically located; devices in different locales are provided with different images and sounds.

### CROSS-REFERENCE TO RELATED APPLICATIONS

This application claims the benefit of U.S. Provisional Patent Applications Nos. 60/745,236 and 60/864,234, filed Apr. 20, 2006 and Nov. 3, 2006, respectively, the entire disclosures of both of which are hereby incorporated herein by reference.

### FIELD OF THE INVENTION

The present invention relates generally to a device, system and method for creation and dissemination of customized postcards.

### DISCUSSION OF THE RELATED ART

It has long been known that individuals, and particularly tourists, like to take photographs of interesting sights when traveling. The photographs serve as a memento from a trip, allow for preservation of certain aspects of the trip, and can be subsequently used by the travelers to reminisce about the trip, and/or to share experiences from the trip with other individuals who were absent from the trip.

For years, tourists have been taking photographs with conventional film-based cameras. More recently, digital cameras have become commercially available and widely used. In the case of either type of camera, after taking the photographs, the photographer typically takes the film from the conventional camera or an electronic memory card from the digital camera and physically transports it to a photograph development facility where the images are fixed in tangible form on paper, etc. to form conventional photographs. Various equipment and techniques for chemical photograph development for film cameras and electronic photograph development, e.g. printing, for digital cameras are well known in the art.

With respect to development of photographs taken with a digital camera, conventional practices also include taking the memory card to a pharmacy, camera store, department store, etc. where there are professionally operated machines that are capable of producing printed photographs from the memory card. The individual may leave the memory card at the store and return to retrieve the memory card and printed photographs. Additionally, some such stores provide machines that are accessible to the photographer, and permit the photographer to operate the machine to produce printed photographs without the involvement of a professional/store employee. This may involve insertion of a digital camera's memory card into the machine, or wireless communication between a camera phone and the machine, e.g. via Bluetooth, IrDA or other wireless technology. Such machines for producing printed photographs from digital camera memory cards are well known in the art. One example of such a machine is the KODAK® Picture Maker machine available at many CVS® pharmacies. In either case, travel to a shopping mall, etc. is required to have access to such a machine. Accordingly, distribution and sharing of such photographs is typically done at a later time, after returning home, after receiving the printed photographs in the mail, etc., i.e. typically after returning from the trip.

Other conventional practices involve use of the photographer's own personal computer that is configured with software for manipulating computer data files retrieved from a memory card and printing them to a local printer, or to upload the computer data files retrieved from the memory card via a network to a central photograph production facility, such as dotphoto.com, ofoto.com, snapfish.com, or the like. Such facilities often provide the option of not only having printed photographs mailed to the photographer, but also hosting of the photographic images on the facility's web server so that the photographer/videographer and other individuals may view the images via a network connection using their respective personal computers, etc. Such facilities and hardware and software for providing such functionality are well known in the art. However, many travelers, particularly those on sightseeing vacations, do not carry their personal computers, or their printer equipment with them. Accordingly, distribution and sharing of such photographs is typically done at a later time, after returning home, after receiving the printed photographs in the mail, etc., i.e. typically after returning from the trip.

What is needed is a device for creation of postcards, and for dissemination of such postcards (or other image files) in electronic and/or physical formats, that does not require a photographer/videographer to have a PC, or an electronic mail (e-mail) account from which to send electronic postcards to recipients in electronic format. Further, such a device is needed at a convenient, readily accessible location, so that there is no need for a traveler to identify a facility having an image printing machine, or to travel to such a facility, particularly when the traveler is traveling in unfamiliar territory or has limited travel time.

### SUMMARY OF THE INVENTION

The present invention provides a device, system and method for creation and dissemination of customized postcards. The device includes hardware of a conventional type typically found in photograph development machines for creating printed photographs from a memory card of a digital (still or video) camera or a cell phone (collectively “digital camera”) capable of taking still photographs and/or motion video (collectively, “pictures”). Accordingly, the device includes at least a microprocessor, a memory, a video display device, a user input device and a multi-format memory card reader capable of reading image data files from a variety of different digital camera-compatible memory cards. Further, the device includes instructions stored in the memory and executable by the microprocessor to provide a graphical user interface via the video display device that has certain image manipulation tools found in conventional photograph editing and greeting card production functionality. Further, the device includes instructions stored in the memory and executable by the microprocessor to permit a user to use an input device to browse and select still or video images (collectively, “images”) stored on a memory card received in the memory card reader, and to perform additional functions as described below.

In one embodiment, the graphical user interface is configured to receive an intended recipient's email address provided by the user, and to transmit selected still or video images to the recipient via a communications network, e.g. as attachments to an e-mail message to the recipient's email address. Similar functionality is provided for sending a postcard image, which includes a selected still or video image, as described below.

Optionally, the graphical user interface allows for creation of an electronic message (such as an e-mail message) including a postcard image including both the image and text provided by an operator of the device via the input device. The message is configured to give the visual impression of a postcard that includes not only the selected image retrieved from the memory card, but also text provided by the photographer/tourist. Such text may be provided by the photographer/tourist by selecting a particular sentiment from a menu of sentiments that are pre-stored by the device in the device's memory, or by using an input device, such as a keyboard, to provide free-form text. Optionally, the device may include a commercially available signature capture pad type input device for capturing the sender's signature or handwritten sentiment, which may then be added to the postcard image.

Optionally, the graphical user interface is configured to automatically add locale-related (e.g. locale-identifying) text to the postcard image (on the front or back). Hotel/resort (“facility”) text, such as the hotel/resort's name and telephone number, may also be automatically added to the postcard image in a similar manner. Optionally, the device also stores in its memory predefined templates that include layouts, borders, backgrounds, etc., and the graphical user interface allows the photographer/videographer/tourist to select a template and add a selected image to create a postcard image.

The graphical user interface allows the photographer/tourist to create a physical printed postcard right at the device by printing the postcard image. The graphical user interface may also allow the photographer/tourist to cause the photographs to be printed at a remote photograph printing facility and have them mailed to an intended recipient. Accordingly, postcards can be received by individuals who cannot operate, do not have, or cannot easily access a personal computer or similar electronic device suited to receiving and viewing electronic mail messages. In the case of printed postcards, a still photographic image may be used, or a single video image, such as a first “frame” of a motion video, may be used as the printed image.

The device preferably stores in its memory or has network access to a plurality of predetermined images that depict areas of interest selected from the same locale in which the device physically resides. Accordingly, a postcard depicting the locale of an individual tourist's trip may be sent by an individual tourist without the need for the individual tourist to have a digital camera, or take any photographs himself/herself.

Optionally, the device stores in its memory of has network access to a plurality of predetermined audio/music files that correspond to the locale in which the device physically resides, e.g., calypso or steel drum music for a Caribbean locale. Accordingly, such a file may be transmitted along with an electronic postcard and may be played by a recipient's PC, etc. for listening while the electronic postcard image is being displayed by the recipient.

In certain embodiments, the device may print and/or dispense a printed promotional item, such as a promotional item for the hotel/resort in which the device is located. For example, such a printed promotional item may include a coupon, voucher or advertisement for a reservation discount, a gift shop item, a meal discount/voucher, a service discount/voucher, etc. redeemable by the hotel/resort, or a third party business partner, e.g. Hertz, Avis, etc.

Preferably, the graphical user interface includes a computer-animated character, such as a parrot, that appears via the video display device to provide audio and/or visual direction to an individual photographer/tourist to guide the individual through the process of using the device to create and/or send a postcard. Optionally, spoken language audio signals may be reproduced by the kiosk in one or more user-selectable languages. Accordingly, the animated character may provide “spoken” guidance in any one of a variety of languages to accommodate a variety of tourists, etc.

The present invention also involves providing such a device, or a system including a plurality of such devices, each of which is physically disposed within a hotel, motel, resort, bed and breakfast or commercial sleeping facility's building, structure (e.g. cruise ship), etc. or within another tourist-attraction facility, such as within an amusement park, theme park, etc., such that individual tourists may have access to such equipment in the same building/facility in which they are already conducting their business for recreational/other purposes, without the need for a separate purpose-specific excursion.

### BRIEF DESCRIPTION OF THE DRAWINGS

The present invention will now be described by way of example with reference to the following drawings in which:

FIG. 1 is a schematic diagram of an exemplary postcard creation device, configured as a freestanding kiosk;

FIG. 2 is an image of an exemplary graphical user interface display window displayable via the device of FIG. 1, in accordance with the present invention;

FIG. 3 is an image of an exemplary e-mail client software display window of a conventional nature, displaying the exemplary electronic postcard of FIG. 2;

FIG. 4 is a flow diagram illustrating an exemplary method of providing the exemplary postcard creation device of FIG. 1;

FIG. 5 is a flow diagram illustrating an exemplary method of distributing an electronic postcard prepared via the device of FIG. 1;

FIG. 6 is a schematic diagram illustrating a networked system including a plurality of postcard creation devices similar to that of FIG. 1; and

FIG. 7 is a schematic diagram of the postcard creation device of FIG. 1.

### DETAILED DESCRIPTION

The present invention provides a device, system and method for creation of an electronic postcard image giving the visual impression of a front and/or back of a physical postcard. Further, the present invention provides a device and system capable of distributing such postcard images in physical form, as printed postcards, and in electronic form, e.g. via an e-mail message including the postcard image or by posting the postcard image on a website where it can be viewed via a communications network such as the Internet.

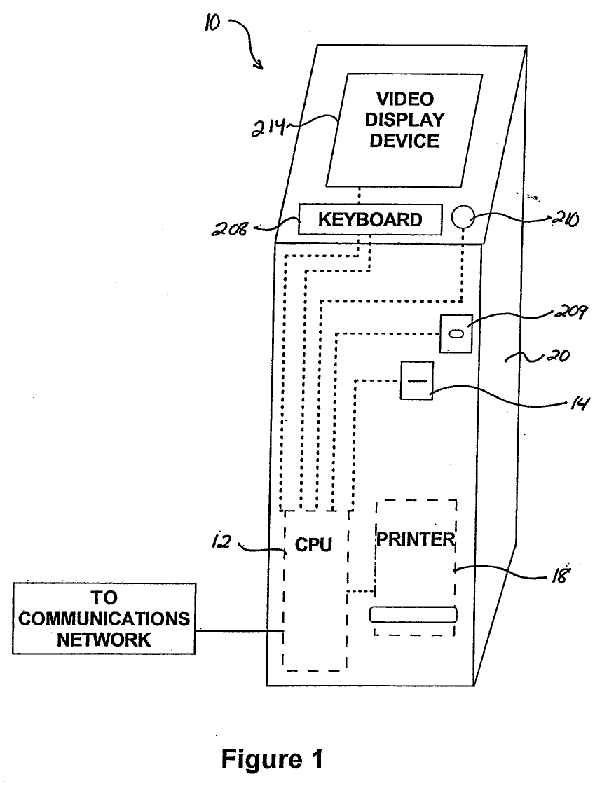

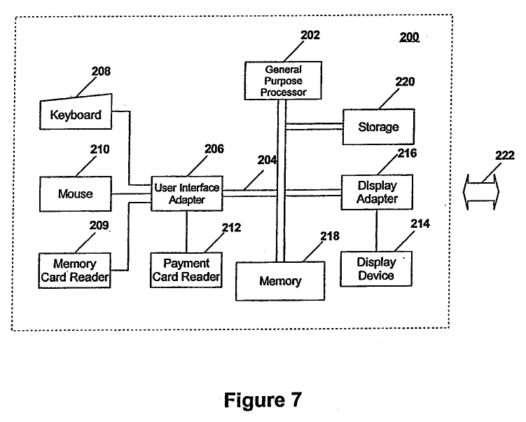

FIG. 1 is schematic diagram of an exemplary postcard creation device 10, configured as a freestanding kiosk. The device 10 includes hardware of a conventional type typically found in digital camera photograph development machines that create printed photographs from images stored on a memory card by a digital camera, wireless phone including a camera, etc. (collectively “digital camera”). Accordingly, as best seen from FIGS. 1 and 7, the device 10 includes at least a microprocessor 202 (e.g. in CPU 12), a memory 218/220, a video display device 214, a user input device/keyboard 208, a mouse/trackball 210, and a multi-format memory card reader 209 capable of reading image data files from a variety of different memory cards of types commonly used by digital cameras, such as CompactFlash (CF) Card, Microdrive, SmartMedia Card (SM), Memory Stick, MultiMediaCard (MMC), and Secure Digital (SD) Card, etc. Such memory card readers are commercially available and well known in the art. The device 10 further includes conventional hardware and software required for communicating via a communications network, e.g. to perform web browsing, file transfer and e-mail functions in conventional manners.

Optionally, the device 10 further includes a receiving device (not shown) for receiving image data (photographic or videographic) from a camera phone. Such a receiving device may be used to transmit image data to the device in an alternative manner to reading it from a memory card. For example, such a receiving device may include an antenna for receiving wireless, e.g. Bluetooth, communications from a camera phone and/or an infrared receiver for receiving wireless infrared, e.g. IrDA, communications from a camera phone. In the description below, reference to the memory card reader includes also reference to such a receiving device.

Optionally, the device 10 also includes a payment reader 14, such as a credit card swipe reader, or bill/currency acceptor, as well known in the art for processing payments. The payment reader 14 may be capable of charging a credit card account, a hotel/resort house/folio account, or the like. Optionally, the payment reader 14 is adapted to read information from a hotel/resort guest's room key card, and to post an appropriate charge to an associated hotel/resort house/folio account. Commercially available hardware and software exists for reading information from hotel/resort guest room key cards and posting charges to an associated hotel/resort house/folio account. In one embodiment, a substantially conventional room key card is modified to display text, a logo, a trademark, etc. advertising and/or promoting the service provided by the kiosk.

Further, the device includes instructions stored in the memory 218/220 and executable by the microprocessor 202 to provide a graphical user interface via the video display device 214 that permits the user to use the input devices 208, 210 (or display device 214 if it is a touchscreen type input device) to browse and select images stored on a memory card inserted into the memory card reader 209 by the user, and to perform additional functions as described below.

In certain embodiments, the device 10 is configured to allow a photographer/videographer/tourist to print a postcard including an image file stored on the memory card. In such an embodiment, the device 10 further includes a conventional printer 18 of a type suitable for producing such postcards, such as a commercially available 300 dpi dye sublimation printer. Optionally, the device is further configured to allow for printing of just photographic images, rather than postcards including photographic images.

Preferably, all such components of the device 10 are housed within a single cabinet 20, such that the device is provided in the form of a free-standing kiosk, as shown in FIG. 1.

The device 10 is configured with specialized software for providing functionality in accordance with the present invention. As part of such functionality, the software provides a graphical user interface that is displayed via the device's video display device 214, and allows a user to interact with the device 10 to create an electronic postcard image, e.g., by providing input via the display device 214, keyboard 208, or mouse/trackball 210. FIG. 2 is an image of an exemplary graphical user interface display window 30 displayable via the video display device 214, in accordance with the present invention.

Referring now to FIG. 2, the graphical user interface display window 30 includes an image preview window 32 that displays thumbnail images of the photographic and/or video image files stored in memory of a digital camera device, e.g. via inserting the digital camera's memory card into the memory card reader 209 of the device, by receiving wireless transmitted data, etc. Such functionality is well known in the art. The graphical user interface is configured to allow a user of the device 10 to select one or more of the thumbnail images for use in creating an electronic postcard image via the display window 30. The graphical user interface display window also includes a front-side display window 34 and a back-side display window 36 that display the front and rear sides of the electronic postcard image 39a, 39b that has been created by an operator of the device 10.

Optionally, the graphical user interface allows for creation of a customized electronic postcard image that includes both the selected image(s) retrieved from the memory card and text provided by a user of input devices of the device 10, as shown in FIG. 2. The electronic postcard image is preferably configured to give the visual impression of a physical postcard that includes not only the selected image received from the digital camera, etc., but also text provided by the photographer/tourist. Optionally, the text may be provided by the photographer/tourist by selecting a particular sentiment from a menu of predefined sentiments that are pre-stored by the system in the system's memory, e.g. “Wish you were here—Jamaica is beautiful!” One or both of the front and back side display windows 34, 36 may have a text entry field 38, into which a user of the device 10 may input freeform text using the device's keyboard 208, touchscreen 214, etc., such as “Jenny and I are having a great time in Jamaica. See you soon. John.”

The graphical user interface display window 30 may also include an address entry field 40 into which a user of the device 10 may input text to identify an address of an intended recipient of the postcard. If the user intends for the recipient to receive an electronic version of the postcard, e.g. via e-mail, then the user may provide an e-mail address. Alternatively, if the user intends for the recipient to receive a physical, printed version of the postcard, e.g. via postal mail or courier, then the user may provide a residential mailing address, etc.

Optionally, the device may include a commercially available signature capture pad type input device for capturing the sender's signature, handwritten sentiment, etc. as text, which may then be similarly added to the postcard image.

Optionally, the graphical user interface is configured to automatically add locale-related text to the electronic postcard image. This text is not provided by the user of the device. Instead, the device 10 is specially configured for use in a particular locale, and to provide such locale-related text. For example, the locale-related text may identify the locale from which the postcard is being sent (e.g. to add text JAMAICA when the device is being operated to read a memory card physically present in JAMAICA), or the hotel, etc.'s name, telephone number, etc. from which the postcard image is being sent (e.g., JAMAICA HOTEL), etc. In FIG. 2, exemplary text 42 is shown in both the front side and back side display windows 32, 34 for illustrative purposes.

Optionally, the system also stores in its memory, or has network access to, predefined templates that include layouts, borders, backgrounds, etc., and the graphical user interface allows the photographer/tourist to select a template and add a selected image to create a customized postcard image. The templates may include stock images and/or text specific to the geographic locale, hotel, motel, resort, etc. in which the kiosk is located. The templates may further include specific areas defined in a predetermined spatial relationship, in which text and/or images may be added to create a customized postcard, etc. Similar templates, layouts, borders, backgrounds, etc. are generally known in the digital photography and digital desktop publishing fields.

Optionally, the device stores in its memory of has network access to a plurality of predetermined audio/music files that correspond to the locale in which the device physically resides, e.g., calypso or steel drum music for a Caribbean locale in which calypso and steel drum music are recognizable characteristic elements of the Caribbean culture. Accordingly, such a file may be transmitted along with an electronic postcard and may be played by a recipient's PC, etc. for listening while the electronic postcard image is being displayed by the recipient.

Optionally, the system also stores in its local memory, or has network access to (collectively, “stores in its memory”), a plurality of predetermined images that depict areas of interest selected from the same locale in which the system physically resides. For example, if the system is physically located in a hotel in Jamaica, the system stores in its memory a plurality of predetermined images that depict areas of interest of Jamaica. For example, such images may be obtained by a professional photographer, and yet be accessible to individual tourists through the system's graphical user interface to create a postcard image including such a “stock” photograph. Accordingly, a postcard depicting the locale of an individual tourist's trip may be sent by an individual tourist without the need for the individual tourist to have a digital camera, or to take any photographs himself/herself. The graphical user interface display window 30 provides a user-selectable command 44 to allow the user to access and select from among such stock photographs for inclusion in a customized postcard image.

Any selected images, automatically provided text, user provided text, templates, etc. are displayed in the postcard front and rear side display windows 34, 36 so the user can view an electronic version of the postcard he or she is creating via the device 10.

Preferably, the graphical user interface includes a computer-animated character (not shown), such as a parrot, that appears via the video display device to provide audio and/or visual direction to an individual photographer/tourist to guide the individual through the process of using the system to create and/or send a postcard. Audio speakers (not shown) may be provided as part of the device 10 for this purpose. Optionally, the character may provide audible, e.g. a voice signal, and/or visual, e.g. on-screen textual, step-by-step instructions that guide an operator of the device through the steps necessary for creation an electronic postcard image and/or delivery of physical and/or electronic versions of the postcard. Preferably, the instructions may be delivered visually or audibly in any one of a plurality of different languages, according to a user's preference/selection via the graphical user interface.

Preferably, the device is configured to require payment for beginning or completing creation and/or dissemination of postcards. Payment can be made through the credit card swipe reader, or it can accept bills through an operatively connected bill acceptor device provided as part of the device 10 (not shown), of a type well known in the art. Additionally, the graphical user interface may provide an option allowing the user to input a “guest code” that will result in any of the charges incurred by the device being added to a house account/hotel room bill. Technology and techniques for implementing this functionality is well known in the art.

Optionally, the graphical user interface allows the photographer/tourist to cause the electronic postcard image to be printed on postcard paper, etc. via a nearby/local printer, e.g. a printer 18 within the cabinet 20 of the device 10. Accordingly, the display window 30 may include a user-selectable option 46 to initiate such printing of a physical postcard.

In certain embodiments, the device may print and/or dispense a printed promotional item, such as a promotional item for the hotel/resort in which the device is located. For example, such a printed promotional item may include a coupon, voucher or advertisement for a reservation discount, a gift shop item, a meal discount/voucher, a service discount/voucher, etc. redeemable by the hotel/resort, or a third party business partner, e.g. Hertz, Avis, etc.

Additionally, the graphical user interface may allow the photographer/tourist to cause the postcard image to be printed at a remote photograph printing facility to crate a physical postcard, so that the remote facility can then mail the physical postcard to the intended recipient. Accordingly, the display window 30 may include a user-selectable option 48 to initiate transmission of data relating to the postcard image, recipient address, etc. via a communications network to such a facility, such as dotphoto.com's facility, dotphoto.com having business operations in West Trenton, N.J., USA. Selection of this option results in display of another window (not shown) via the video display device 214 that permits the user to input the recipient's mailing/residential address. Accordingly, postcards created and distributed in this manner can be received by individuals who cannot operate, do not have, or cannot easily access a personal computer or similar electronic device suited to receiving and viewing e-mail messages or electronic/web images.

Additionally, the graphical user interface may allow the photographer/tourist to cause the postcard image to be delivered in electronic format to the intended recipient. Accordingly, the display window 30 may include a user selectable option 50 to initiate transmission of data relating to the postcard via a communication network to the intended recipient, e.g. at the e-mail address provided for the intended recipient. Preferably, in such an embodiment, the postcard image is sent from an e-mail server of a system that provides and/or is associated with the device, such that the recipient receives an e-mail message including the postcard from an e-mail account that is not the sender's own personal e-mail account. In this manner, a tourist can send such a postcard as e-mail without the need for his/her own e-mail account, or access to his/her personal e-mail account. Alternatively, such a postcard image may be uploaded to a user's web-mail account, such as a Yahoo!, hotmail or g-mail account, and be sent via the individual's own email account.

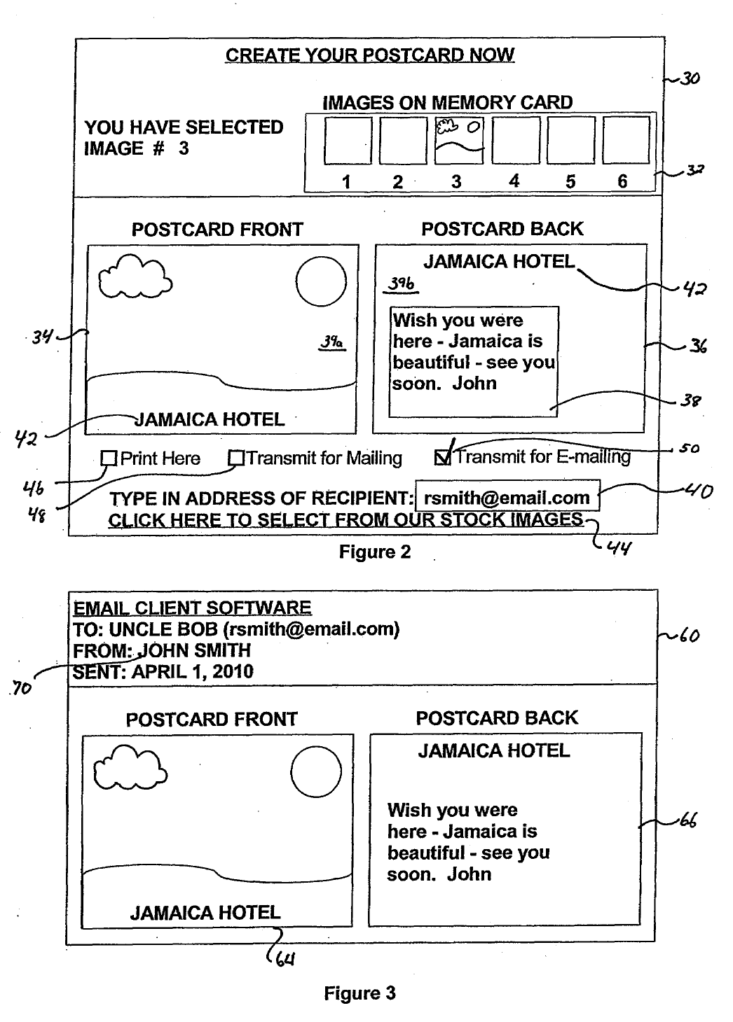

FIG. 3 is an image of an exemplary e-mail client software display window 60 that is viewed at the recipient's personal computer, etc. by a recipient of an e-mail message including the postcard image. The e-mail client software is conventional in nature, and any suitable software may be used. The display window 60 of FIG. 3 displays the exemplary postcard image of FIG. 2 that was produced in accordance with the present invention. In this exemplary embodiment, the postcard image/electronic postcard is received as part of a conventional e-mail message and includes images of the front and rear sides 64, 66 of the postcard that are displayed within the body of the email message. Alternatively, a conventional e-mail message is provided that includes primarily text in its body, and includes the postcard image(s) as an attachment to the email.

Optionally, the email message includes text 70 identifying the name of the photographer/tourist that operated the device 10, but is sent from an email address/email server of the system, i.e. not from the sender's own personal email account. Alternatively, the system's email address or alias is shown as the sender of the email message.

Other display windows (not shown) may be provided to carry out the functionality described above, or other functionality.

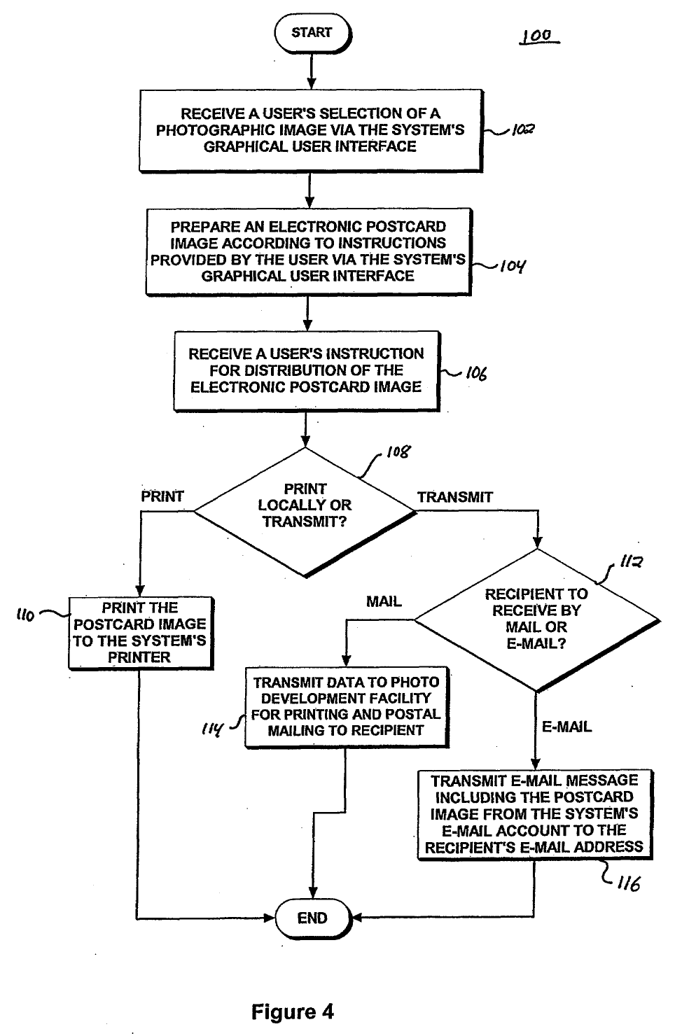

FIG. 4 is a flow diagram 100 illustrating an exemplary method of providing the exemplary postcard creation device of FIG. 1. As shown in FIG. 4, the method begins with receipt of a user's selection of an image via the systems'graphical user interface, as shown at step 102. For example, this may involve the user's insertion of a memory card from his/her digital camera into the memory card reader 209 of the device and by using a touchscreen 214 or mouse/trackball 210 to select thumbnail image 3. Alternatively, this may be achieved by selecting the option/link 44 to view the “stock” images provided by (e.g., stored in a memory of) the device, and to select one of those images in a similar manner.

Next, the user operates the device 10, by interacting with the graphical user interface displayed via the video display device to 14, to prepare an electronic postcard image, such as that shown in display windows 34, 36 of FIG. 2, has shown at step 104. For example, this may include selecting images stored on the memory card or otherwise accessible via the device 10, selecting from a displayed menu of templates, borders, color schemes, etc. provided by (e.g. stored in a memory of) the device, providing a textual message by selecting a stock word or phrase provided by (e.g., stored in the memory of) the device or by operating the keyboard, etc. to provide free-form text, operating a signature capture pad to provide a digital version of the user's signature, to provide a audio/music file to accompany an e-mail transmission of the postcard, etc., and using the graphical user interface to arrange these elements relative to one another to provide the postcard image.

It should be noted that the kiosk may be configured to automatically contribute elements to the postcard image, e.g. to include stock images, text, etc., as discussed above.

The device then receives a user's instruction for dissemination of the electronic postcard image, as shown at step 106. As shown in the exemplary graphical user interface display window 30 of FIG. 2, the user can provide such instruction by checking/selecting one of the “Print Here,” “Transmit for Mailing,” or “Transmit for E-mailing” checkboxes shown at 46, 48 and 50.

It is then determined whether the instruction is to print the postcard image locally, or to transmit data representing the postcard image to the intended recipient in electronic (e.g., e-mail message or web-posting) form, or to a printing facility for creating a printed version of the postcard and mailing it to the intended recipient, as shown at step 108.

If the instruction is to print the postcard image locally, e.g. by checking box 46, then appropriate signals are sent to a nearby printer, such as an attached printer 18 within the cabinet 20 of the device 10, as shown at step 110. In this manner, the user of the device is provided with immediate access to a printed version of the postcard.

If the instruction is to transmit data representing the postcard image, then it is determined whether the user of the device 10 intends for the recipient to receive a physical version of the postcard by courier/postal mail (collectively, “mail”), or an electronic version of the postcard by electronic mail, web access to a hosted image, etc. (collectively, “e-mail”), as shown at step 112. Optionally, the system may permit sending of both physical and electronic versions of a single postcard by both mail and e-mail, to a single recipient or to multiple different recipients.

If the instruction is to have the recipient receive a physical version of the postcard by mail, e.g. as evidenced by selection of the “Transmit for Mailing” checkbox 48, then the system transmits appropriate data to a photograph development facility for printing and mailing to the intended recipient, as shown at step 114. Accordingly, the device 10 may allow for the user, implicitly or explicitly, to add and/or pay for postage for physical mailing of such postcards. By way of example, an electronic postage service, such as stamps.com, may be used to cause the kiosk to print postage indicia directly on the printed postcard, and payment may be collected by the kiosk. Alternatively, payment for postage can be collected by the kiosk, and a conventional stamp or printed stamp indicia may be applied to the printed postcard at a later time. The data transmitted may include the mailing address of the intended recipient that was provided by the user of the device 10 via the graphical user interface display window 30. For example, dotphoto.com, ofoto.com, snapfish.com and other commercial enterprises exist to provide such functionality. Preferably, the device 10 is operated by an enterprise that is engaged in a business relationship with a photograph development facility and a selection on the part of the user of this dissemination option results in direction of the request to the operator's photo development facility business partner.

If the instruction is to have the recipient receive an electronic version of the postcard by e-mail, e.g. as evidenced by selection of the “Transmit For E-mailing” checkbox 50, then the system transmits appropriate data to the intended recipient, as shown in step 116. This may be performed using the e-mail address provided by the user of the device 10 via the graphical user interface display window 30. Preferably, the device is configured to send such an e-mail message from an e-mail address and/or e-mail account administered by, owned by and/or controlled by the enterprise that distributes/operates the devices, and not from the photographer/tourists own personal e-mail account, which may be difficult or impossible to access when traveling. For example, the enterprise distributing/operating the devices may form a business relationship with Yahoo, AOL, or similar entity that will provide this type of e-mail distribution and/or file hosting for Web access functionality.

In alternative embodiments, the kiosk may include functionality allowing for local printing (at the kiosk) of non-postcard, e.g. regular photographic, images, or to transmit postcard or non-postcard (e.g., regular photographic) images to a remote location, such as a CVS, Wal-mart or other store, where they will be locally printed and available for in-store pickup. For example, in this manner a travelling person may transmit photographic images electronically via the kiosk to a pharmacy near the person's residence (the kiosk user specifying and/or selecting a specific retail store location), and the pharmacy will receive such image data via a communications network, print the photographic images (postcards or photographs), and hold them for pickup by the person, or another person, after returning from a trip, etc. For example, this will allow the traveler to avoid the need to carry such photographs on a return trip, and to have such photographs essentially immediately upon returning to a home town, etc.

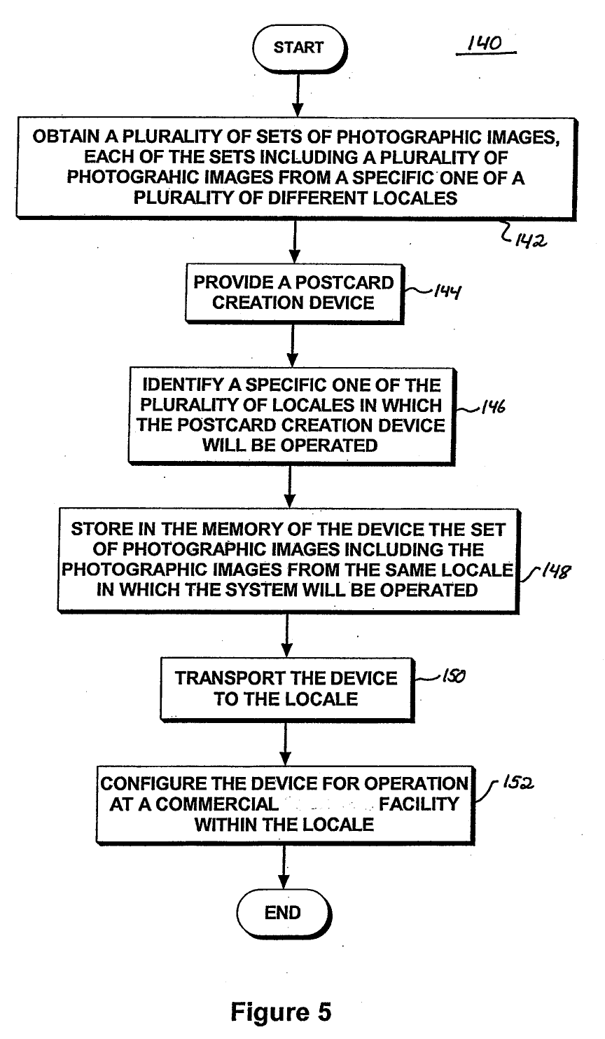

FIG. 5 is a flow diagram 140 illustrating an exemplary method of distributing an electronic postcard prepared via the device of FIG. 1. As shown in FIG. 5, the exemplary method begins with obtaining of a plurality of sets of images, is shown at step 142. Each of the sets includes a plurality of different images taken in a specific one of a plurality of different geographic locales. For example, a first set may include 35 photographic or videographic images taken on the island of Jamaica, and a second set may include 43 photographic or videographic images taken on the island of Hawaii.

Next, the method involves providing a postcard creation device, as shown at step 144. For example, this may involve having assembled a device 10 such as that shown in FIG. 1.

Then, a specific one of the plurality of geographic locales in which the postcard creation device will be operated is identified, shown at step 146. For example, this may involve determining that there's a need or intention to install one of the devices 10 in a particular hotel in Jamaica.

Accordingly, the method involves storing in the memory of the device the set of images that includes images taken in the same geographic locale in which the system will be operated, as shown at step 148. In other words, this step involves storing the first set of images from photos taken on the island of Jamaica in the device that will be shipped to and installed for operation on the island of Jamaica. It should be noted that in an alternative embodiment, the set of images is not stored in a memory physically located within the device, but rather is made accessible via the device, e.g. via a communications network.

The device is then transported to the specific geographic locale for which it was configured for operation, as shown in step 150. The device is then configured for operation at a commercial facility (e.g. amusement park, tourist area, building, cruise ship, or other structure) within the geographic locale, as shown at step 152. For example, this may involve connecting the device to a power supply, communications network hub, etc.

Accordingly, FIG. 5 describes a method involving installation of a single device 10. However, it should be noted that there is preferably a system of multiple devices 10, each of which is installed in a distinct commercial facility, such as an amusement park, hotel, motel, resort, inn, bed and breakfast, cruise ship, etc. and among a plurality of different geographical locales. As will be appreciated from FIG. 5, each device is specially configured for use within a specific geographic locale, e.g. to include facility name text, locale-specific stock photographs, etc.

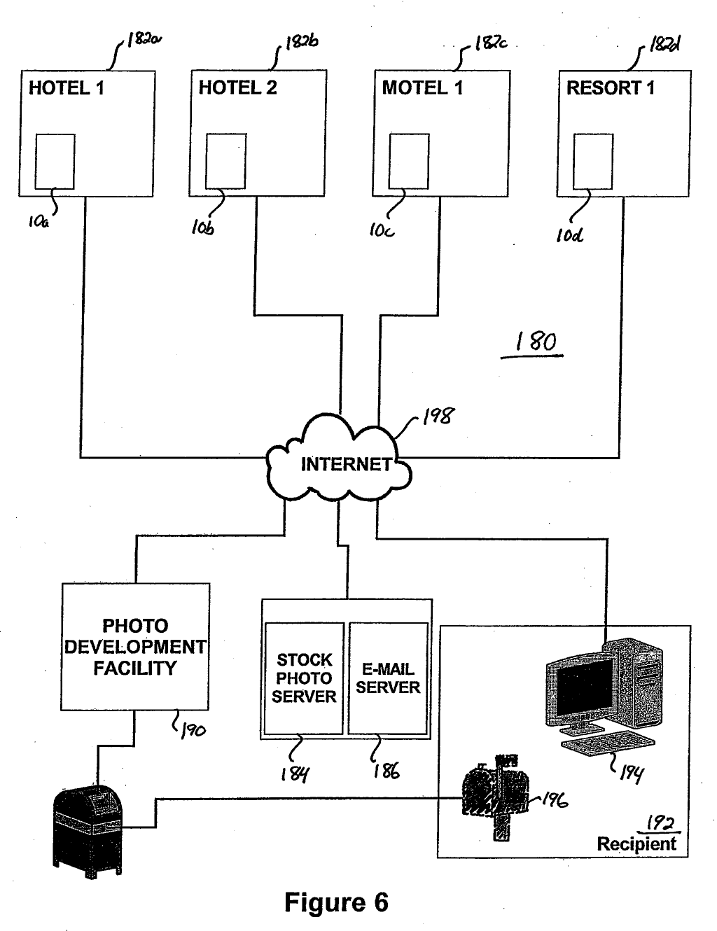

FIG. 6 is schematic diagram illustrating a networked system 180 including a plurality of postcard creation devices similar to that of FIG. 1. In the exemplary system 180 of FIG. 6, there is a respective device 10a, 10b, 10c, 10d installed in each of four different commercial facilities, namely, a first hotel building 182a, a second hotel building 182b, a first motel building 182c, and a first resort building 182d. For illustrative purposes, it can be assumed that hotel 182a and resort 182d are both located in Jamaica, hotel 182b is located in Hawaii and motel 182c is located in Antigua. In accordance with one embodiment of the present invention, device 10a and 10d store in their respective memories stock images taken on the island of Jamaica, device 10b stores in its memory stock images taken on the island of Hawaii, and device 10c stores in its memory stock images from taken on the island of Antigua.

Shown also is a centralized stock photograph server 184, which in certain embodiments stores the sets of locale-specific images rather than have the sets stored on the individual devices themselves. In such an embodiment, each respective device is configured so that a user of the device can access via the device only the set of local-specific images that correspond to the locale in which the device resides, e.g. Jamaican images for the device in Jamaica. Such servers are known in the art and beyond the scope of the present invention.

Shown also is a centralized email server 186 that can be used to process and distribute e-mail messages including postcard images, host postcard images for web access, etc. Such servers are known in the art and beyond the scope of the present invention.

Also shown is a photo development facility 190, such as dotphoto.com, ofoto.com or snapfish.com, which is capable of receiving e-mailed and/or uploaded postcard images from the devices, printing physical postcards including the postcard images, mailing the physical postcards and/or e-mailing electronic postcard images. Such facilities are known in the art and beyond the scope of the present invention.

Shown also is an individual recipient's household, etc. 192, which includes a computing device running web browsing and/or email client software for receiving and displaying electronic postcard images, and a mailbox/mail receiving facility for receiving packages sent by courier and/or postal mail, e.g. from photo development facility 190 or by a user of one of the devices that chose to print a postcard image locally and mail the physical postcard himself or herself.

As shown in FIG. 6, the devices 10a, 10b, 10c, 10d, the photo development facility 190, the stock photo server 184, the e-mail/web server 186 and the recipient's computer device 194 are operably connected for communication via a communications network 198, such as the Internet.

FIG. 7 is a block diagram of a computerized system 200 in accordance with the present invention. The system 200, which includes conventional computer hardware storing and executing specially configured computer software for carrying out a method and for performing the functionality described above in accordance with the present invention.

Accordingly, the system 200 of FIG. 7 includes a general purpose microprocessor (CPU) 202 and a bus 204 employed to connect and enable communication between the microprocessor 202 and the components of the server 200 in accordance with known techniques. The server 200 typically includes a user interface adapter 206, which connects the microprocessor 202 via the bus 204 to one or more user interface/input devices, such as a keyboard 208, mouse/trackball 210, memory card reader 209 and payment card reader and/or other interface devices 212, which can be any user interface device, such as a touch sensitive screen, digitized entry pad, etc. The bus 204 also connects a display device 214, such as an LCD screen or monitor or a touchscreen monitor, to the microprocessor 202 via a display adapter 216. The bus 204 also connects the microprocessor 202 to memory 218 and long-term storage 220 (collectively, “memory”) which can include a hard drive, diskette drive, tape drive, etc.

The system 200 may communicate with other computers or networks of computers, for example via a communications channel, network card or modem 222. The system 200 may be associated with such other computers in a local area network (LAN) or a wide area network (WAN), and operates as a server in a client/server arrangement with another computer, etc. Such configurations, as well as the appropriate communications hardware and software, are known in the art.

The system's software is specially configured in accordance with the present invention. Accordingly, as shown in FIG. 7, the system 200 includes various software-implemented components configured to implement one or more aspects described above.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A method for creating and disseminating a customized postcard, the method comprising a user:
operating a digital camera to obtain a user image, the user image being represented an image data file stored in a memory of the digital camera;
transmitting the image data file from the memory of the digital camera to a computerized postcard creation device having a display device and an image memory for storing a plurality of stock image data files;
tendering payment to the postcard creation device;
operating the postcard creation device to create an electronic postcard image including a user-selected image selected by the user from a group of images displayed via the display device, the group of images including the user image, the electronic postcard image being displayed via a display device of the postcard creation device; and
operating the postcard creation device to send the electronic postcard image by transmitting from the postcard creation device to a remote location, via the electronic communications network, data representing the electronic postcard image.

2. The method of claim 1, wherein the group of images consists of the user image and a stock image represented by a corresponding stock image data file stored in the image memory of the postcard creation device's memory.

3. The method of claim 2, wherein each of the stock image data files corresponds to an image depicting a specific geographic locale in which the postcard creation device is physically located.

4. The method of claim 1, further comprising:
operating the postcard creation device to provide text for inclusion in the electronic postcard image;
the electronic postcard image including both the user-selected image and the text, the electronic postcard image being displayed via the display device.

5. The method of claim 4, wherein operating the postcard creation device to provide text for inclusion in the electronic postcard image comprises the user operating an input device of the postcard creation device to select a sentiment from a predetermined menu of alternative sentiments displayed via the display device of the postcard creation device.

6. The method of claim 4, wherein operating the postcard creation device to provide text for inclusion in the electronic postcard image comprises the user operating an input device of the postcard creation device to type free-form text.

7. The method of claim 1, wherein the remote location comprises a printer for printing the electronic postcard image to create a printed physical object, the method further comprising the user traveling to the remote location to retrieve the printed physical object.

8. A method for creation and dissemination of customized postcards, the method comprising:
obtaining a plurality of sets of images, each of said plurality of sets of images comprising a plurality of images depicting a respective specific one of a plurality of different geographic locales;
providing a plurality of postcard creation devices, each postcard creation device comprising a microprocessor, a memory operatively connected to the microprocessor, a display device, a user input device and microprocessor-executable instructions stored in the memory and configured to provide via the display device a graphical user interface operable to create an electronic postcard image including a user-selected image;
storing in the memory of each of the plurality of devices a selected one of said plurality of sets of images that comprises a plurality of images depicting a certain respective geographic locale;
transporting each of the plurality of devices to the corresponding certain respective geographic locale; and
configuring each of the plurality of devices for operation at a respective commercial facility within the corresponding certain respective geographic locale, each device at each respective geographic locale being operable to create an electronic postcard image including a image depicting the corresponding certain geographic locale.

9. A device for creation and dissemination of customized postcards, the device comprising:
a microprocessor;
a display device;
an input device configured to receiving instructions from a user;
a network communications device for communicating data via an electronic communications network;
a data port capable of receiving image data files from a digital camera;
a payment reader capable of processing a user's payment;
a memory operatively connected to the microprocessor; and
microprocessor-executable instructions stored in the memory and configured to provide via the display device a graphical user interface operable to permit a user to:
select a user-selected image from among a plurality of images displayed via the display device;
create an electronic postcard image including the user-selected image; and
select a user-selected delivery option for disseminating the electronic postcard image, the user-selected delivery option being selectable from a menu of delivery options, the menu of delivery options comprising at least one of:
a first option for transmitting from the device, via the electronic communications network, data for printing the electronic postcard image at a remote location; and
a second option for transmitting from the device, via the electronic communications network, data for delivering the electronic postcard image to an intended recipient via the electronic communications network.

10. The device of claim 9, wherein the data port comprises a multi-format memory card reader capable of reading image data files from a plurality of digital camera-compatible memory cards.

11. The device of claim 9, wherein the data port comprises a receiving device capable of receiving data via wireless transmission.

12. The device of claim 9, wherein the memory stores a predetermined selected set of images comprising a plurality of images depicting a certain geographic locale in which the device is physically located, and wherein the plurality of images displayed via the display device comprise both images retrieved from the memory and images corresponding to image data files received from a digital camera via the data port.

13. The device of claim 9, wherein the graphical user interface is operable to permit a user to select from a menu text for inclusion in the electronic postcard image.

14. The device of claim 9, wherein the graphical user interface is operable to permit a user to provide via the input device free-form text for inclusion in the electronic postcard image.

15. The device of claim 9, further comprising:
a printer for printing the electronic postcard image onto postcard paper at the device;
the menu of delivery options comprising a third option for printing the electronic postcard image onto postcard paper at the device.

16. The device of claim 15, wherein the printer is operable to print postage indicia onto the postcard paper, and the device is operable to accept payment from the user for the applicable postage.

17. The device of claim 9, further comprising:
a signature capture pad for capturing the user's handwriting, the device being configured to include a digitized version of the user's captured handwriting in the electronic postcard image.

18. The device of claim 9, wherein the device is configured to automatically include predetermined text in the electronic postcard image, the predetermined text identifying at least one of a name of a geographic locale, a name of a commercial facility, and a telephone number of the commercial facility.

19. The device of claim 9, wherein the memory stores a plurality of predetermined audio files comprising audible sounds corresponding to a certain geographic locale in which the device is physically located, and wherein the second option for transmitting data from the device for delivering the electronic postcard image to an intended recipient via the electronic communications network comprises an option to transmit a user-selected audio file with the electronic postcard image.

20. The device of claim 9, wherein the device is configured to automatedly dispense a printed promotional item selected from a group consisting of: a coupon, a voucher or an advertisement.

21. The device of claim 9, wherein the payment reader is capable of reading data from a hotel room key card, and posting a charge to a folio account associated with the hotel room key card.

22. A computerized device for creation and dissemination of customized postcards, the device comprising:
a microprocessor;
a memory for storing microprocessor-executable instructions;
a display device for displaying information to a user;
an input device configured to receive instructions from a user;
a network communications device for communicating data via an electronic communications network;
a data port capable of receiving image data;
a payment reader capable of processing a user's payment; and
microprocessor-executable instructions stored in the memory and configured to display via the display device a graphical user interface operable to:
display via the display device a plurality of images including at least one image corresponding to image data received from the user via the data port and at least one predetermined image depicting a locale in which the device is physically located;
permit a user to select a user-selected image from among the plurality of images displayed via the display device,;
permit a user to create an electronic postcard image including the user-selected image; and
permit a user to disseminate the electronic postcard image by transmitting from the device to a remote location, via the electronic communications network, data representing the electronic postcard image.
